(19) United States
(12) Patent Application Publication
(10) Pub. No.: US 2011/0157917 A1
(43) Pub. Date: Jun. 30, 2011

(54) Backlight Module with Localized Light Source Control

(75) Inventors: Chih-Wei Chang, Hsin-Chu (TW); Ming-Lung Chen, Hsin-Chu (TW); Deng-Kuen Shiau, Hsin-Chu (TW); Chih-Kang Tung, Hsin-Chu (TW)

(73) Assignee: AU OPTRONICS CORPORATION, Hsin-Chu (TW)

(21) Appl. No.: 12/908,054

(22) Filed: Oct. 20, 2010

(30) Foreign Application Priority Data
Dec. 30, 2009 (TW) 098145980

(51) Int. Cl. F21V 8/00

(52) U.S. Cl. 362/613

(57) ABSTRACT

A backlight module with localized light source control is provided. The backlight module includes a first light guide plate, a second light guide plate, and a plurality of luminous elements. The first light guide plate includes a first side. The second light guide plate includes a second side. The first and second light guide plates are disposed along a first direction, so that the first side of the first light guide and the second side of the second light guide face to each other. The luminous elements are respectively disposed along the first side and the second side and emit lights thereto, wherein at least a portion of the luminous elements disposed along the first side and the second side form a light source module so as to act simultaneously.

This application claims priority based on a Taiwanese Patent Application No. 098145980, filed on Dec. 30, 2009, the disclosure of which is incorporated herein by reference in its entirety.

### BACKGROUND OF THE INVENTION

1. Field of the Invention

The present invention relates to a backlight module; particularly, the present invention relates to a backlight module with localized light source control.

2. Description of the Related Art

Since the liquid crystal of LCD (liquid crystal display) is not self-luminous, additional light source is required for LCD to display images. A backlight module disposed behind LCD panel is generally utilized as the light source of LCD. The backlight module is principally composed of a light guide plate and a plurality of luminous elements. Lights generated from the luminous elements are transmitted by the light guide plate and evenly emitted to the LCD panel, so that the LCD panel can perform the display function.

As liquid crystal televisions and their related products are getting popular nowadays, how to overcome the restrictions on manufacturing processes, cost, etc., to produce larger sized products is critical to the competitiveness of the products. Under such a demand for larger sized product, a method of combining several small light guide plates to form a large light guide plate set is set forth. This method makes the manufacturing of larger sized backlight module easier and satisfies the strict size requirement for LCD. Furthermore, the luminous elements can emit lights to individual light guide plate of the light guide plate set as desired to fulfill the local dimming function of the backlight module.

FIG. 1A is a schematic view of a conventional backlight module. As shown in FIG. 1, light sources 2 are disposed on two opposite sides of the light guide plate 1. Each light guide plate 1 is divided into three blocks (e.g. block A to C), and each block corresponds to a light source set (e.g. light source set a to c). Each light source set is composed of the light sources 2 disposed on two opposite sides of the corresponding block. Three light guide plates 1 altogether have nine blocks A to I, which correspond to nine light sources sets a to i, respectively. Each light source set can be independently activated to achieve the local dimming function.

However, since the light source sets are divided in accordance with individual light guide plate 1 and restricted to the layout of the light guide plates 1, when the local dimming function is performed, an obvious bright/dim boundary is easy to be formed at the joint of two light guide plates 1, and the distribution of light in the light guide plate 1 is not uniform. For instance, when only block E is illuminated by the light source set e, an obvious bright/dim boarder X will be formed between block E and block B, as shown in FIG. 1B. As such will cause the backlight module to output non-uniform light and impair the display effect of LCD.

### SUMMARY OF THE INVENTION

It is an objective of the present invention to provide a backlight module to eliminate the bright/dim boundary formed at the joint between different light guide plates, so that the distribution of light in light guide plates can be more uniform so as to resolve the above-mentioned prior art problem.

The backlight module of the present invention includes a first light guide plate, a second light guide plate, and a plurality of luminous elements. The first light guide plate includes a first side. The second light guide plate includes a second side. The first light guide plate and the second light guide plate are disposed along a first direction, so that the first side of the first light guide plate and the second side of the second light guide plate face to each other. The luminous elements are disposed along the first side and the second side and respectively emit lights toward the first side and the second side, wherein at least a portion of the luminous elements disposed along the first side and the second side forms a light source module to act simultaneously, so that a lighting block can be formed between the first light guide plate and the second light guide plate. The structure of forming a lighting block between different light guide plates will cause the light produced by the backlight module to be distributed in gradient, so that the bright/dim boundary formed at the joint between different light guide plates can be alleviated during performing the local dimming function.

### BRIEF DESCRIPTION OF THE DRAWINGS

FIG. 1A is a schematic view of a conventional backlight module;

FIG. 1B is a schematic view of the use of the conventional backlight module shown in FIG. 1A;

FIG. 2 is a schematic view of the first embodiment of the backlight module of the present invention;

FIG. 3 is a schematic view of another embodiment of the lighting blocks of the backlight module shown in FIG. 2;

FIG. 4A is a schematic view of an embodiment of the connection of the luminous elements of the backlight module shown in FIG. 2 or FIG. 3;

FIG. 4B is a schematic view of another embodiment of the connection of the luminous elements of the backlight module shown in FIG. 2 or FIG. 3;

FIG. 5 is a schematic view of the second embodiment of the backlight module of the present invention;

FIG. 6 is a schematic view of the third embodiment of the backlight module of the present invention;

FIG. 7A is a schematic view of an embodiment of the connection of the luminous elements of the backlight module shown in FIG. 6;

FIG. 7B is a schematic view of another embodiment of the connection of the luminous elements of the backlight module shown in FIG. 6;

FIG. 8A is a schematic view of the fourth embodiment of the backlight module of the present invention;

FIG. 8B is a schematic view of the fifth embodiment of the backlight module of the present invention;

FIG. 9 is a flow chart of an exemplary method of using the backlight module of the present invention; and

FIG. 10 is a flow chart of another exemplary method of using the backlight module of the present invention.

### DETAILED DESCRIPTION OF THE PREFERRED EMBODIMENT

The present invention provides a backlight module. In a preferred embodiment, the backlight module of the present invention is applied to flat panel displays. However, in other embodiments, the backlight module can be applied to other devices in need of backlight source.

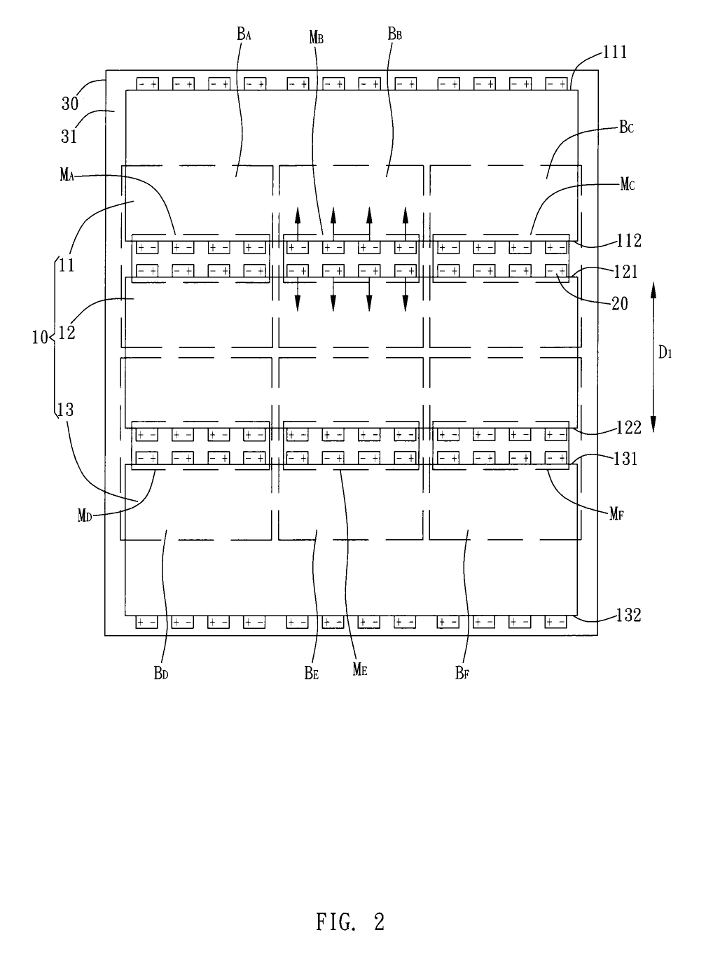

FIG. 2 is a schematic view of the first embodiment of the backlight module of the present invention. As shown in FIG. 2, the backlight module includes a light guide plate set 10, a plurality of luminous elements 20, and a substrate 30. The light guide plate set 10 includes a first light guide plate 11, a second light guide plate 12, and a third light guide plate 13. The first light guide plate 11 has a first side 112. The second light guide plate 12 has a second side 121 and a third side 122 opposite to the second side 121. The third light guide plate 13 has a fourth side 131. The first light guide plate 11, the second light guide plate 12, and the third light guide plate 13 are disposed side by side along a first direction D₁, so that the first side 112 and the second side 121 face to each other and, and the third side 122 and the fourth side 131 face to each other.

In a preferred embodiment, the luminous elements 20 are side-emitting diodes. As shown in FIG. 2, multiple luminous elements 20 are disposed along the sides 111 to 132 of the first light guide plate 11, the second light guide plate 12, and the third light guide plate 13, so that the luminous elements disposed along the first side 112 and the second side 121 can respectively emit lights toward the first side 112 and the second side 121; the luminous elements disposed along the third side 122 and the fourth side 131 can respectively emit lights toward the third side 122 and the fourth side 131; the luminous elements 20 disposed along other sides of the first light guide plate 11 and the third light guide plate 13, i.e. the side 111 and the side 132, can emit lights toward the side 111 and the side 132, respectively.

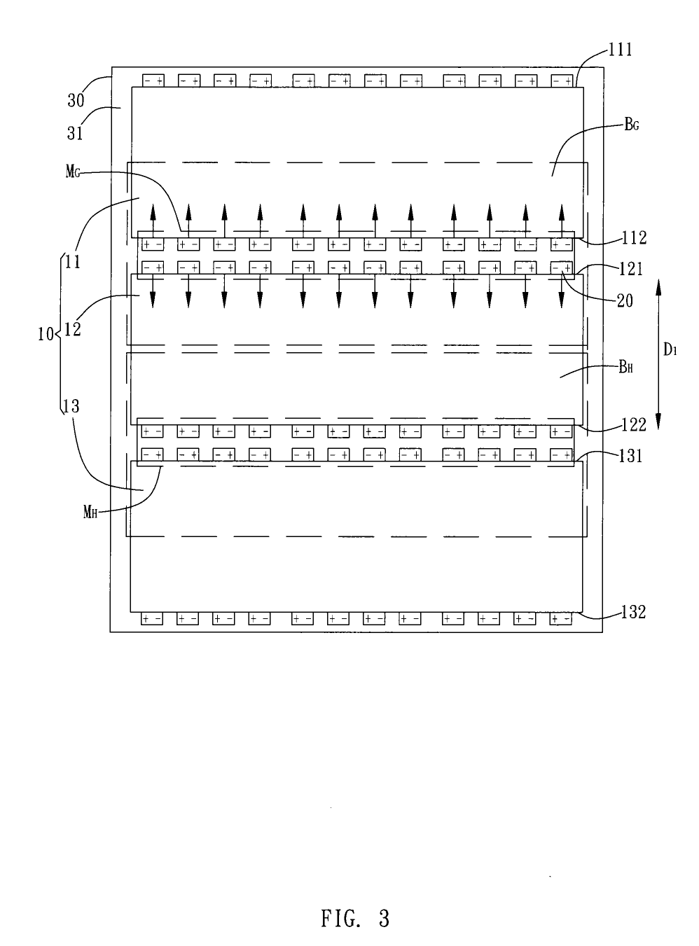

In this embodiment, lighting blocks B_{A}, B_{B}, and B_{C} respectively cover a portion of the first light guide plate 11 and a portion of the second light guide plate 12, so that the blocks B_{A}, B_{B}, and B_{C} are arranged across two light guide plates. Lighting blocks B_{D}, B_{E}, and B_{F} respectively cover a portion of the second light guide plate 12 and a portion of the third light guide plate 13, so that the blocks B_{D}, B_{E}, and B_{F} are arranged across two light guide plates. The luminous elements 20 disposed along the first side 112 and the second side 121 are divided into three light source modules M_{A}, M_{B}, and M_{C} respectively corresponding to the blocks B_{A}, B_{B}, and B_{C}. Similarly, the luminous elements 20 disposed along the third side 122 and the fourth side 131 are divided into three light source modules M_{D}, M_{E}, and M_{F} respectively corresponding to the blocks B_{D}, B_{E}, and B_{F}. The length of the block can be defined by the length of the light source module and associated with the length of the corresponding light guide plate. For instance, in this embodiment, the length of the light guide plate is an integral multiple of the length of the corresponding block or light source module. However, in other embodiments, as shown in FIG. 3, the length of the block or the length of the light source module can be equal to the length of the corresponding light guide plate. In the embodiment shown in FIG. 3, the block B_{G} lies across the first light guide plate 11 and the second light guide plate 12 with the light source module M_{G} included therein. The length of the block B_{G} or the length of the light source module M_{G} is equal to the length of the first light guide plate 11 or the second light guide plate 12. The block B_{H} lies across the second light guide plate 12 and the third light guide plate 13 with the light source module M_{H} included therein. The length of the block B_{H} or the length of the light source module M_{H} is equal to the length of the second light guide plate 12 or the third light guide plate 13. The luminous elements 20 in a same light source module act simultaneously, i.e. can be optionally turned on or turned off simultaneously. For instance, the luminous elements 20 in the light source module M_{A} as shown in FIG. 2 can be turned on or turned off simultaneously. Different light source modules such as the light source module M_{B} and the light source module M_{C} shown in FIG. 2 can be independently controlled. In other words, individual light source module can be independently operated so as to perform the local dimming function based on a unit of block. For instance, the block B_{B} or the block B_{C} can serve as a unit block to perform the local dimming function.

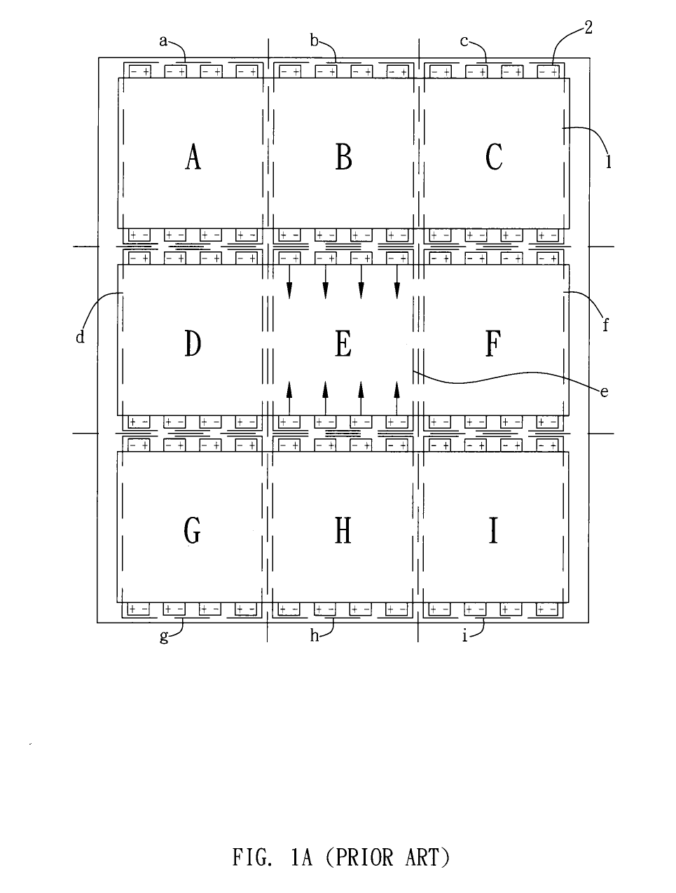

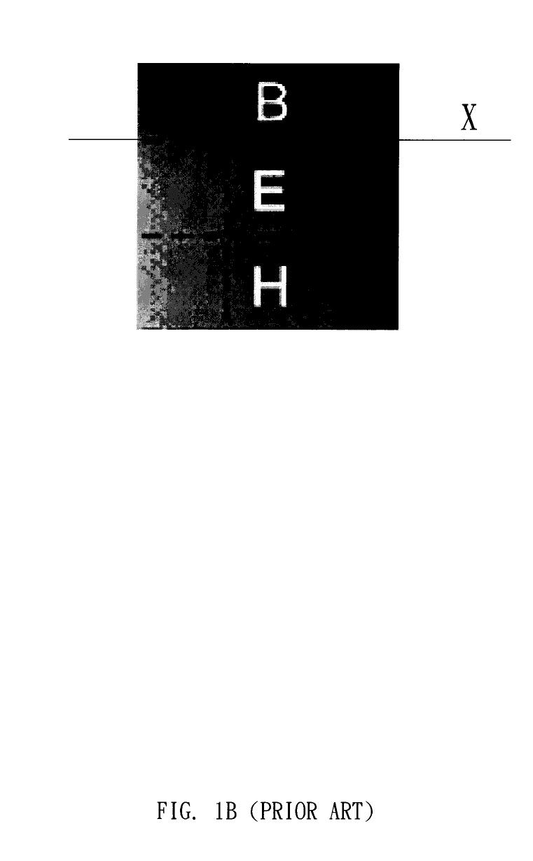

In prior arts, since the edge of each block coincides with the edge of the corresponding light guide plate. As a result, when performing the local dimming function, an obvious bright/dim boundary will be formed along the edges of adjacent light guide plates between an active block (e.g. the block E shown in FIG. 1A) and an inactive block (e.g. the block B or H shown in FIG. 1A), which are separated by air, because light transmitted through different materials will cause the light decay. In this embodiment, as shown in FIG. 2, the structure of forming the lighting blocks across different light guide plates will separate the edge of each light block from the edge of the light guide plate. Consequently, when performing the local dimming function, the bright/dim boundary between an active block (e.g. the block B_{B}) and an adjacent inactive block (e.g. the block B_{A}, B_{C}, or B_{E}) will be less obvious than the prior arts. Moreover, the light generated by the light source module (e.g. light source module M_{B}) will exhibit a gradient effect of brightness at the edge of each block (e.g. the block B_{B}). Besides, other luminous elements 20 not assigned to the given light source module can be independently activated if necessary.

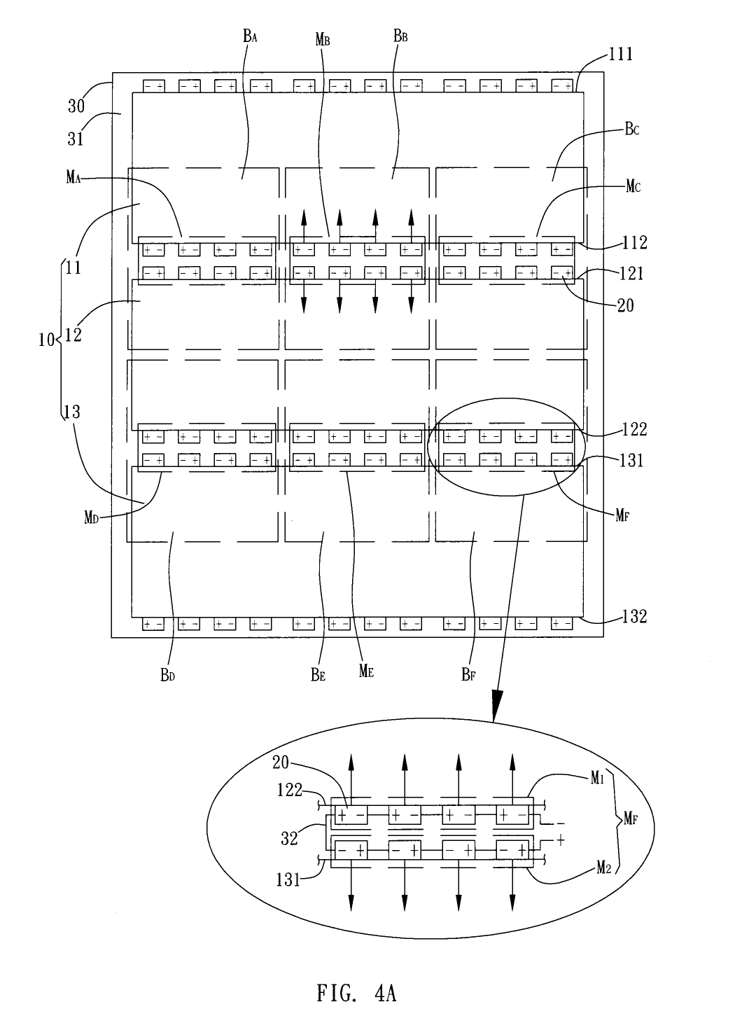

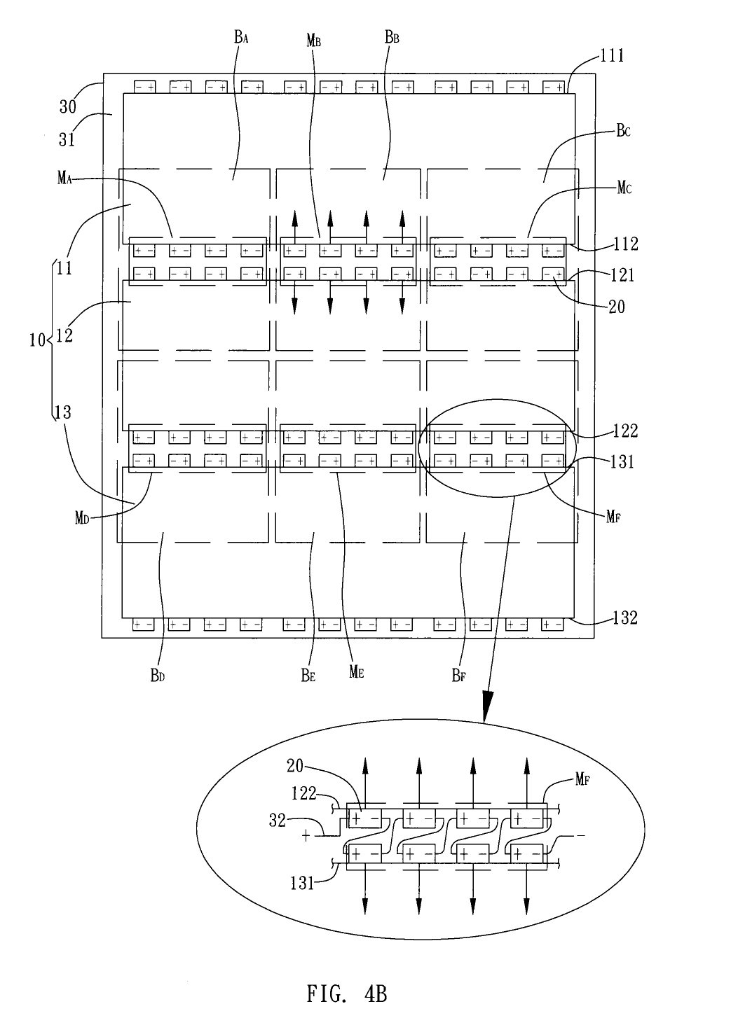

In this embodiment, the substrate 30 is a complete piece of rectangular circuit board which includes a surface 31 and a wiring 32 as shown in FIG. 4A and FIG. 4B. All of the light guide plates and the luminous elements 20 are disposed on the surface 31 of the same substrate 30. In other words, all of the light guide plates overlap the substrate 30, and the luminous elements 20 are connected to each other through the wiring 32. In a preferred embodiment, the substrate 30 is a printed circuit board while the wiring 32 is a circuit formed on the printed circuit board by etching process.

FIG. 4A is a schematic view of an embodiment of the connection of the luminous elements of the backlight module shown in FIG. 2 or FIG. 3. As shown in FIG. 4A, through the connection of wiring 32, the luminous elements 20 disposed along the third side 122 of the second light guide plate 12 are connected in series to form a first luminous element set M₁ while the luminous elements 20 disposed along the fourth side 131 of the third light guide plate 13 are connected in series to form a second luminous element set M₂. The first luminous element set M₁ and the second luminous element set M₂ are in turn connected in series to form the light source module M_{E}. In the embodiment as shown in FIG. 2 or FIG. 3, different light source modules (e.g. light source modules M_{A}, M_{B}, M_{C}, M_{G}) are independently supplied with power, so that each light source module (e.g. light source module M_{A}, M_{B}, M_{C}, M_{G}) can be separately controlled. Similarly, the luminous elements 20 disposed along other sides 111, 122, 131 or 132 of the first light guide plate 11, the second light guide plate 12, and the third light guide plate 13 can be connected in series in a same manner to form the corresponding light source module such as the light source module M_{D}, M_{E}, M_{F}, or M_{H}.

FIG. 4B is a schematic view of another embodiment of the connection of the luminous elements of the backlight module shown in FIG. 2 or FIG. 3. As shown in FIG. 4B, through the connection of wiring 32, the luminous elements 20 disposed along the third side 122 of the second light guide plate 12 and the fourth side 131 of the third light guide plate 13 are interlaced and connected in series to form the light source module M_{F}. In other words, each of the luminous elements 20 disposed along the third side 122 is connected to another corresponding luminous element 20 disposed along the fourth side 131. In the embodiment shown in FIG. 2 or FIG. 3, different light source modules (e.g. light source modules M_{A}, M_{B}, M_{C}, M_{G}) are independently supplied with power, so that each light source module (e.g. light source module M_{A}, M_{B}, M_{C}, M_{G}) can be separately controlled. Similarly, the luminous elements 20 disposed along other sides 111, 122, 131 or 132 of the first light guide plate 11, the second light guide plate 12, and the third light guide plate 13 can be connected in series in a same manner to form the corresponding light source module such as light source module M_{D}, M_{E}, M_{F}, or M_{H}. In other embodiments, the light source module consisting of series-connected luminous elements 20 and the light source module consisting of interlaced and series-connected luminous elements 20 can be disposed in a same backlight module. In other embodiments, the luminous elements 20 can be connected in other electrical connection manners, as long as the luminous elements 20 in a same light source module can be operated simultaneously and separately from the luminous elements 20 in other light source modules.

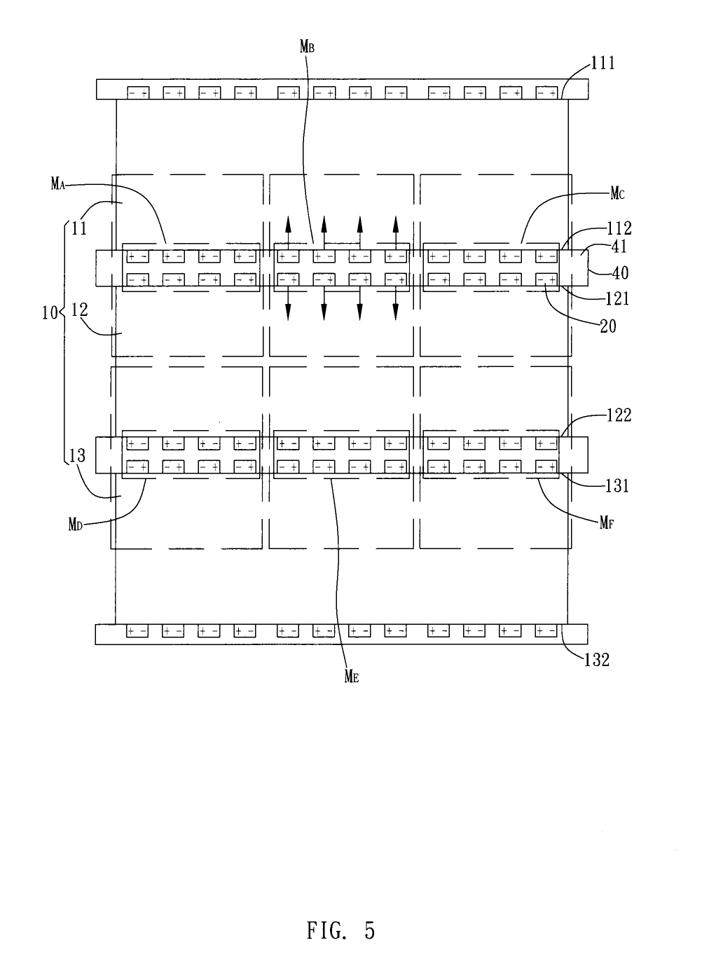

In the embodiment as shown in FIG. 2 or FIG. 3, the substrate 30 is a rectangular circuit board which has the advantage of simple in shape and therefore easy to cut and easy to be arranged. However, in other embodiments, other type of substrate can be utilized. FIG. 5 is a schematic view of the second embodiment of the backlight module of the present invention. As shown in FIG. 5, the backlight module includes a light guide plate set 10, a plurality of luminous elements 20, and a substrate 40. The light guide plate set 10 includes a first light guide plate 11, a second light guide plate 12, and a third light guide plate 13. The first light guide plate 11 has a first side 112; the second light guide plate 12 has a second side 121 and a third side 122 opposite to the second side 121; the third light guide plate 13 has a fourth side 131. The substrate 40 has an elongated shape. The substrate 40 between the first light guide plate 11 and the second light guide plate 12 is disposed along the first side 112 and the second side 121 while the substrate 40 between the second light guide plate 12 and the third light guide plate 13 is disposed along the third side 122 and the fourth side 131, so that there is only a portion of the light guide plates overlaps the corresponding substrate. Utilizing a plurality of elongated boards has the advantage of, for example, reducing the area of circuit board, simplifying the circuit, promoting the yield, and saving cost. Furthermore, besides the above-mentioned sides of the first light guide plate 11, the second light guide plate 12, and the third light guide plate 13, other parallel sides of the light guide plates have corresponding substrates 40. The substrate 40 includes a surface 41 and a wiring (not shown). The luminous elements 20 are disposed on the surface 41 and connected to each other by the wiring. In a preferred embodiment, the substrate 40 is a printed circuit board while the wiring is a circuit formed on the printed circuit board by etching process. The relationship between the wiring, the luminous elements 20, and the light source module M_{A} to M_{F} can refer to the description of FIG. 4A or FIG. 4B and will not be elaborated again.

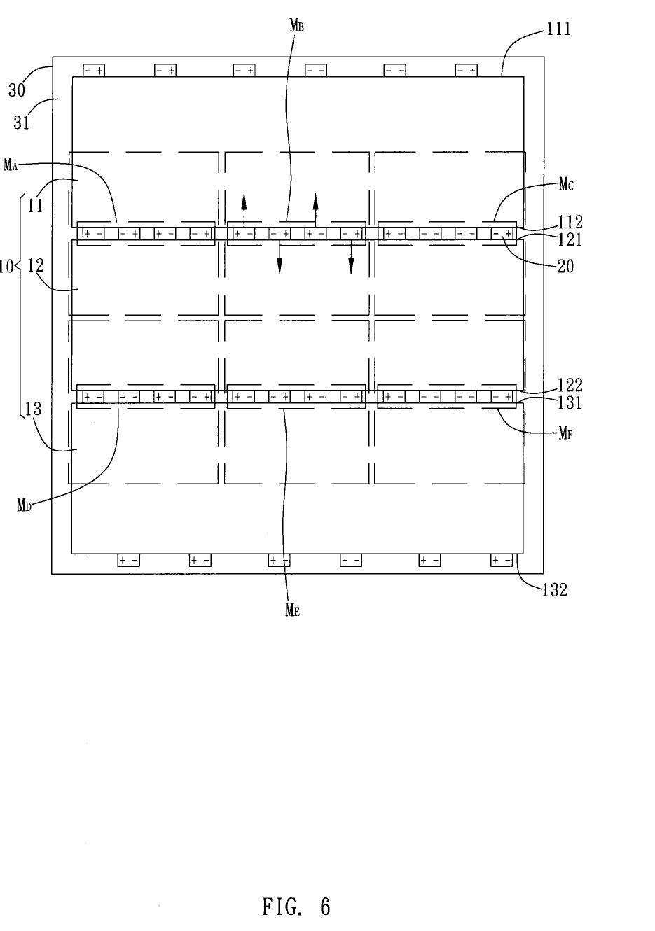

As the embodiment shown in FIG. 2, FIG. 3, or FIG. 5, multiple luminous elements 20 are respectively disposed along the sides of the first light guide plate 11, the second light guide plate 12, and the third light guide plate 13, so that the luminous elements 20 disposed along the first side 112 of the first light guide plate 11 and the second side 121 of the second light guide plate 12 are opposite to each other while the luminous elements 20 disposed along the third side 122 of the second light guide plate 12 and the fourth side 131 of the third light guide plate 13 are also opposite to each other. As a result, the luminous elements 20 disposed on adjacent sides form a dual array structure. However, in other embodiments, the luminous elements 20 can be disposed in other manners. FIG. 6 is a schematic view of the third embodiment of the backlight module of the present invention. As shown in FIG. 6, the luminous elements 20 disposed along the first side 112 of the first light guide plate 11 and the second side 121 of the second light guide plate 12 are interlaced to form a single line structure while the luminous elements 20 disposed along the third side 122 of the second light guide plate 12 and the fourth side 131 of the third light guide plate 13 are interlaced to form another single line structure. Such an arrangement can reduce the distance between different light guide plates so as to eliminate the influence of distance on the uniformity of light distribution in the backlight module. Furthermore, since the luminous elements 20 for emitting lights toward the sides 112, 121, 122, and 131 are respectively arranged in a single line structure, the number of required luminous elements 20 of this embodiment is fewer than the number of the luminous elements 20 for emitting lights toward the sides 112, 121, 122, and 131 as shown in FIG. 2, FIG. 3, and FIG. 5. Hence, in order to achieve a uniform light distribution in the backlight module, the number of the luminous elements 20 for emitting lights toward the sides 111 and 132 of this embodiment is also fewer than the number of luminous elements 20 for emitting lights toward the sides 111 and 132 as shown in FIG. 2, FIG. 3, and FIG. 5. The luminous element having higher brightness can be utilized as the luminous elements 20 in the embodiment as shown in FIG. 6 to maintain appropriate brightness. As the number of the luminous elements 20 is reduced, the disposing time and the cost of the luminous elements 20 can be accordingly saved.

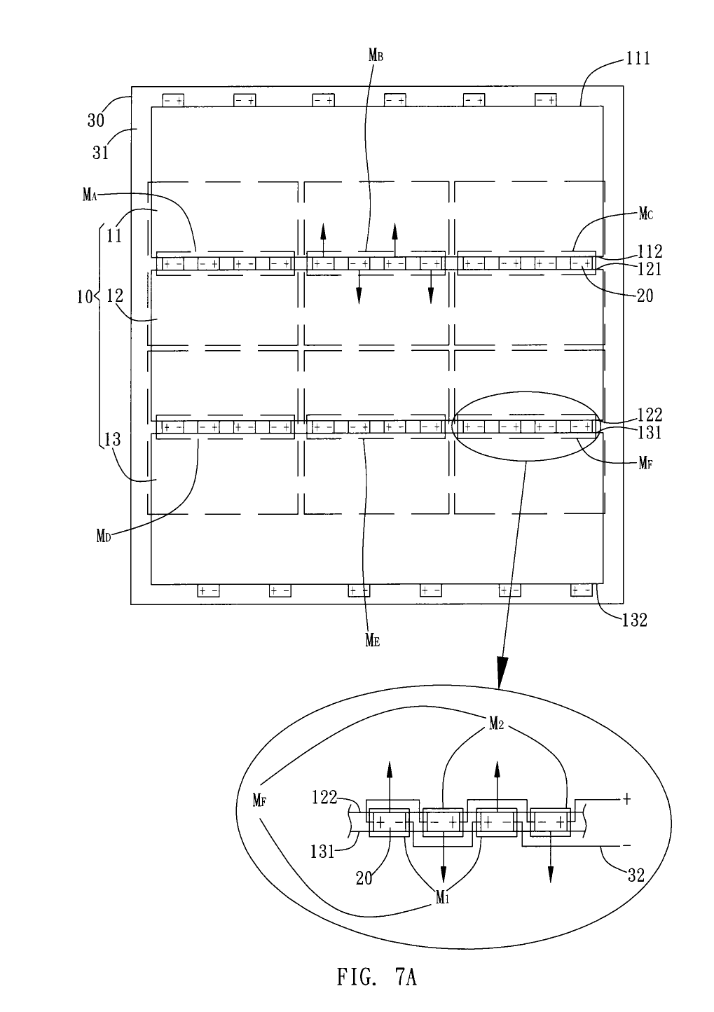

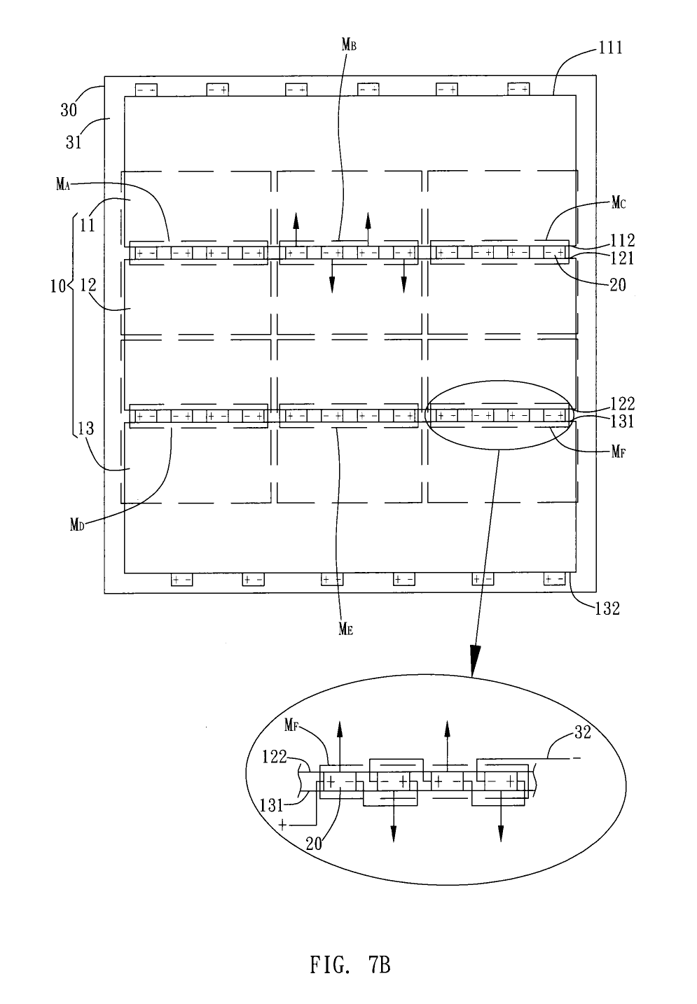

FIG. 7A is a schematic view of an embodiment of the connection of the luminous elements of the backlight module shown in FIG. 6. As shown in FIG. 7A, the luminous elements 20 for emitting lights toward the third side 122 of the second light guide plate 12 are connected in series to form a first luminous element set M₁ while the luminous elements 20 for emitting lights toward the fourth side 131 of the third light guide plate 13 are connected in series to form a second luminous element set M₂. The first luminous element set M₁ and the second luminous element set M₂ are in turn connected in series to form the light source module M_{E}. In the embodiment as shown in FIG. 6, different light source modules (e.g. light source modules M_{A}, M_{B}, and M_{C}) are independently supplied with power, so that individual light source module (e.g. light source module M_{A}, M_{B}, or M_{C}) can be separately controlled. However, in other embodiments, adjacent light source modules can be connected in series to simplify the control circuit. Similarly, the luminous elements 20 for emitting lights toward other sides 111, 122, 131 or 132 of the first light guide plate 11, the second light guide plate 12, and the third light guide plate 13 can be connected in series in a same manner to form the corresponding light source module such as the light source modules M_{D}, M_{E}, M_{F}. In other embodiments, the light source modules shown in FIGS. 4A, 4B, and/or 7A can be disposed in a same backlight module.

FIG. 7B is a schematic view of another embodiment of the connection of the luminous elements of the backlight module shown in FIG. 6. As shown in FIG. 7B, the luminous elements 20 disposed along the third side 122 of the second light guide plate 12 and the fourth side 131 of the third light guide plate 13 are interlaced and connected in series to form a light source module M_{F}. In other words, each of the luminous elements 20 for emitting lights toward the third side 122 are connected to another adjacent luminous element 20 for emitting lights toward the fourth side 131. In this embodiment, different light source modules (e.g. light source modules M_{A}, M_{B}, and M_{C}) are independently supplied with power, so that individual light source modules (e.g. light source module M_{A}, M_{B}, or M_{C}) can be separately controlled. Similarly, the luminous elements 20 for emitting lights toward other sides 111, 122, 131 and 132 of the first light guide plate 11, the second light guide plate 12, and the third light guide plate 13 can be connected in series in a same manner to form the corresponding light source module such as light source modules M_{D}, M_{E}, M_{F}. In other embodiments, the light source modules shown in FIGS. 4A, 4B, 7A, and/or 7B can be disposed in a same backlight module.

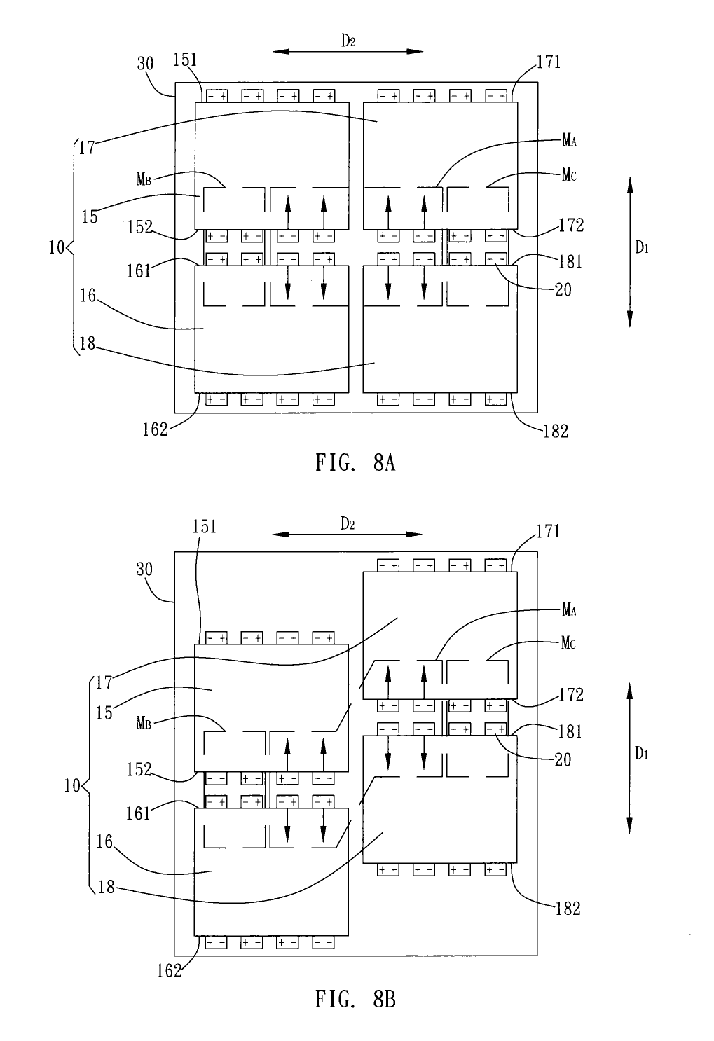

FIG. 8A is a schematic view of the fourth embodiment of the backlight module of the present invention. As shown in FIG. 8A, the backlight module includes a light guide plate set 10, a plurality of luminous elements 20, and a substrate 30. The light guide plate set 10 includes a first light guide plate 15, a second light guide plate 16, a third light guide plate 17, and a fourth light guide plate 18. The first light guide plate 15 includes a first side 152; the second light guide plate 16 includes a second side 161; the third light guide plate 17 includes a third side 172; the fourth light guide plate 18 includes a fourth side 181. The first light guide plate 15 and the second light guide plate 16 are disposed side by side along a first direction D₁ so that the first side 152 and the second side 161 face to each other. The third light guide plate 17 and the fourth light guide plate 18 are disposed side by side along the first direction D₁ so that the third side 172 and the fourth side 181 face to each other. The first light guide plate 15 and the third light guide plate 17 are disposed side by side along a second direction D₂ so that the first side 152 and the third side 172 are adjacent to each other in a straight line. The second light guide plate 16 and the fourth light guide plate 18 are disposed side by side along the second direction D₂ so that the second side 161 and the fourth side 181 are adjacent to each other in a straight line. As a result, the light source module M_{A} is arranged in a rectangular shape.

However, in other embodiments, the light source module M_{A} can have other shape such as irregular shape, parallelogram, etc. other than rectangle. As shown in FIG. 8B, the first side 152 and the third side 172 are not in a straight line while the second side 161 and the fourth side 181 are not in a straight line. As a result, the light source module M_{A} is arranged in an irregular shape. The irregular shape of the light module M_{A} can weaken the boundary line of the light module M_{A} by destroying the continuity of the boundary line so that the boundary line is less obvious.

As shown in FIG. 8A, multiple luminous elements 20 are disposed along the sides of the first light guide plate 15, the second light guide plate 16, the third light guide plate 17, and the fourth light guide plate 18, so that the luminous elements 20 disposed on the first side 152, the second side 161, the third side 172, and the fourth side 181 can emit lights thereto, respectively. The luminous elements 20 disposed on other sides 151, 162, 171, and 182 of the first light guide plate 15, the second light guide plate 16, the third light guide plate 17, and the fourth light guide plate 18 can emit lights toward the corresponding sides 151, 162, 171, and 182, respectively. The luminous elements 20 disposed along the first side 152 and adjacent to the third side 172, the luminous elements 20 disposed along the second side 161 and adjacent to the fourth side 181, the luminous elements 20 disposed along the third side 172 and adjacent to the first side 152, and the luminous elements 20 disposed along the fourth side 181 and adjacent to the second side 161—i.e. the luminous elements 20 disposed on the central portion of the substrate 30, form a light source module M_{A}. Other luminous elements 20 disposed along the first side 152 and the second side 161 form a light source module M_{B} while other luminous elements 20 disposed along the third side 172 and the fourth side 181 form a light source module M_{C}. Luminous elements 20 in a same light source module cam act simultaneously in a manner similar to the embodiments of FIG. 4A, FIG. 4B, FIG. 7A, and FIG. 7A, and different light source modules can be independently controlled. For instance, the light source modules M_{A}, M_{B}, and M_{C} can be independently controlled to perform the local dimming function. In comparison with the above-mentioned embodiments, the light source module M_{A} of this embodiment includes two sets of the luminous elements 20 disposed between the light guide plates abreast-arranged along the first direction D₁—i.e. the luminous elements 20 disposed between the first light guide plate 15 and the second light guide plate 16 and the luminous elements 20 disposed between the third light guide plate 17 and the fourth light guide plate 18. Furthermore, the first light guide plate 15 and the third light guide plate 17 are disposed along a second direction D₂ while the second light guide plate 16 and the fourth light guide plate 18 are also disposed along the second direction D₂. Consequently, when multiple smaller-sized light guide plates are combined to form a bigger-sized light guide plate set, since the light source module M_{A} disposed across different light guide plates in the first direction D₁ and the second direction D₂, the evenness of the outputted lights in both directions can be maintained, and the obvious bright/dim boundary in both directions can be alleviated. Besides, other luminous elements 20 not assigned to the light source module M_{A} can be independently operated if necessary.

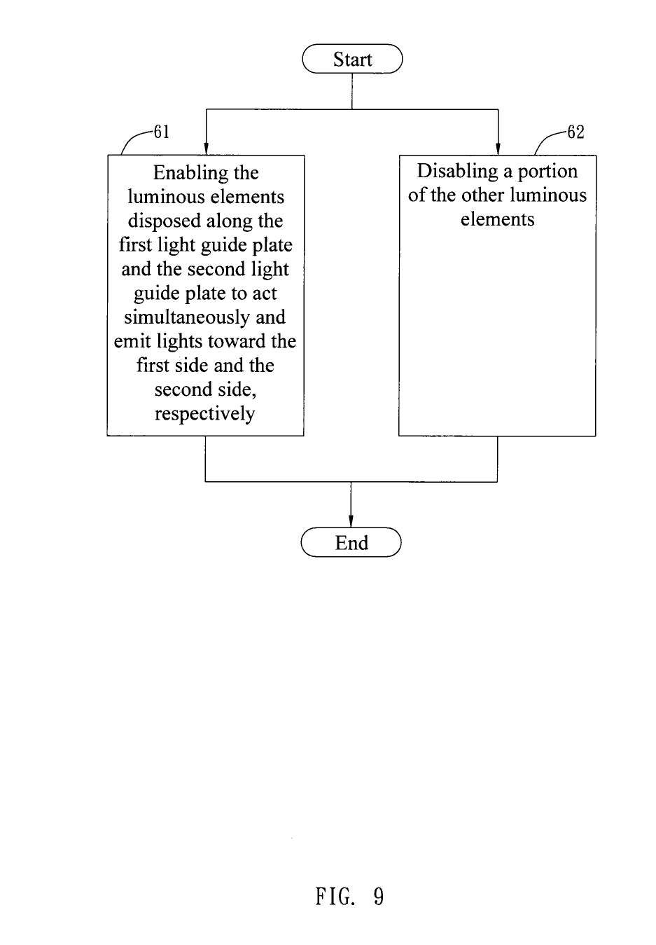

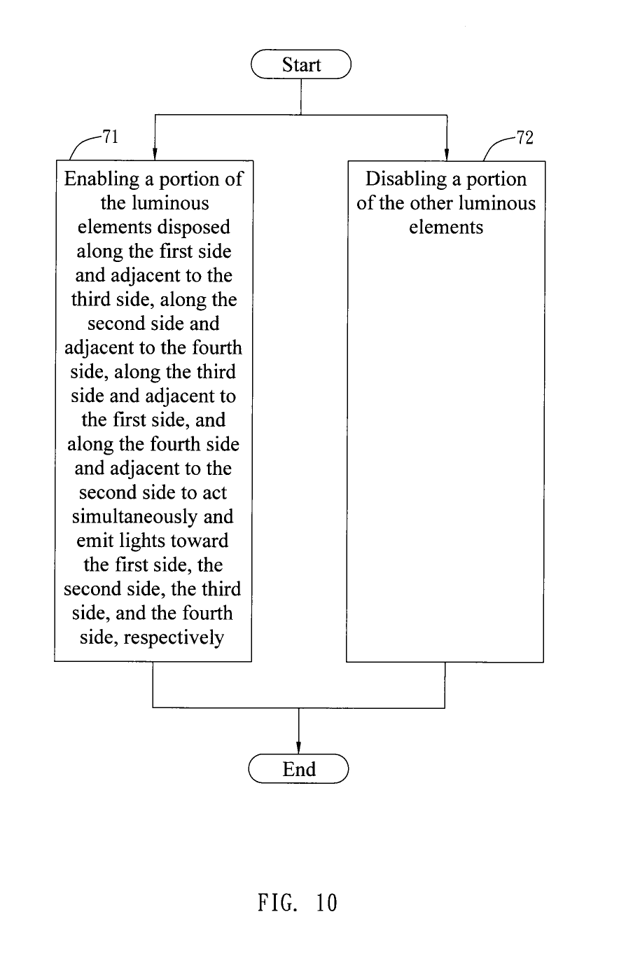

FIG. 9 is a flow chart of an exemplary method of using the backlight module of the present invention. The backlight module includes a first light guide plate, a second light guide plate, and a plurality of luminous elements. The first light guide plate and the second light guide plate have a first side and a second side, respectively. The first and second light guide plates are disposed along a first direction, so that the first side of the first light guide and the second side of the second light guide face to each other. The luminous elements are disposed along the sides of the first and second light guide plates, so that the luminous elements disposed along the first side and the second side can emit lights toward the first side and the second side, respectively. Other luminous elements disposed along the sides other than the first side and the second side of the first light guide plate and the second light guide plate can emit lights toward the corresponding sides, respectively. As shown in FIG. 9, in a preferred embodiment, the step 61 and the step 62 are performed simultaneously. The step 61 includes enabling the luminous elements disposed along the first light guide plate and the second light guide plate to act simultaneously and emit lights toward the first side and the second side, respectively. The step 62 includes disabling a portion of the remaining luminous elements other than those disposed along the first and second sides. However, in other embodiments, all of the remaining luminous elements can be disabled simultaneously.

FIG. 10 is a flow chart of another exemplary method of using the backlight module of the present invention. The light guide plate set includes a first light guide plate, a second light guide plate, a third light guide plate, a fourth light guide plate, and a plurality of luminous elements. The first light guide plate, the second light guide plate, the third light guide plate, and the fourth light guide plate have a first side, a second side, a third side, and a fourth side, respectively. The first light guide plate and the second light guide plate are disposed along a first direction so that the first side and the second side face to each other while the third light guide plate and the fourth light guide plate are also disposed along the first direction so that the third side and the fourth side face to each other. The first light guide plate and the third light guide plate are disposed along a second direction so that the first side and the third side are adjacent to each other in a straight line while the second light guide plate and the fourth light guide plate are also disposed along the second direction so that the second side and the fourth side are adjacent to each other in a straight line. However, in other embodiments, the first side and the third side are not necessary to be disposed in a straight line while the second side and the fourth side are also not necessary to be disposed in a straight line. Multiple luminous elements are respectively disposed along the sides of the first light guide plate, the second light guide plate, the third light guide plate, and the fourth light guide plate, so that the luminous elements disposed on the first side, the second side, the third side, and the fourth side can emit lights thereto while the luminous elements disposed on other sides of the first light guide plate, the second light guide plate, the third light guide plate, and the fourth light guide plate can emit lights toward the corresponding sides, respectively. As shown in FIG. 10, in a preferred embodiment, the step 71 and the step 72 are performed simultaneously. The step 71 includes enabling a portion of the luminous elements, which are disposed along the first side and adjacent to the third side, along the second side and adjacent to the fourth side, along the third side and adjacent to the first side, and along the fourth side and adjacent to the second side, to act simultaneously and emit lights toward the first side, the second side, the third side, and the fourth side, respectively. The step 72 includes disabling a portion of the remaining luminous elements other than the above mentioned luminous elements.

Although the present invention has been described through the above-mentioned related embodiments, the above-mentioned embodiments are merely the examples for practicing the present invention. What need to be indicated is that the disclosed embodiments are not intended to limit the scope of the present invention. On the contrary, the modifications within the essence and the scope of the claims and their equivalent dispositions are all contained in the scope of the present invention.

What is claimed is:

1. A backlight module, comprising:
a first light guide plate having a first side;
a second light guide plate having a second side, wherein the first light guide plate and the second light guide plate are disposed along a first direction, so that the first side of the first light guide face to the second side of the second light guide; and
a plurality of luminous elements, disposed along the first side and the second side, for emitting lights toward the first side and the second side, respectively, wherein at least a portion of the luminous elements disposed along the first side and the second side forms a light source module to act simultaneously.

2. The backlight module of claim 1, further comprising a substrate including a surface and at least a wiring, wherein the first and second light guide plates and the luminous elements are disposed on the surface, the luminous elements are connected to each other by the wiring.

3. The backlight module of claim 1, further comprising a substrate disposed between the first light guide plate and the second light guide plate along the first side of the first light guide plate and the second side of the second light guide plate, wherein the substrate includes a surface and at least a wiring, the luminous elements are disposed on the surface and connected to each other by the wiring.

4. The backlight module of claim 1, wherein the luminous elements disposed along the first side of the first light guide plate are connected in series to form a first luminous element set while the luminous elements disposed along the second side of the second light guide plate are connected in series to form a second luminous element set, and the first luminous element set and the second luminous element set are in turn connected in series to form the light source module.

5. The backlight module of claim 1, wherein the luminous elements disposed along the first side of the first light guide plate and the second side of the second light guide plate are interlaced and connected in series to form the light source module.

6. The backlight module of claim 1, wherein the luminous elements disposed along the first side of the first light guide plate and the second side of the second light guide plate are interlaced to form a single line structure.

7. The backlight module of claim 6, wherein the luminous elements disposed along the first side of the first light guide plate are connected in series to form a first luminous element set while the luminous elements disposed along the second side of the second light guide plate are connected in series to form a second luminous element set, and the first luminous element set and the second luminous element set are in turn connected in series to form the light source module.

8. The backlight module of claim 6, wherein the luminous elements disposed along the first side and the second side are interlaced and connected in series to form the light source module.

9. The backlight module of claim 1, further comprising:
a third light guide plate having a third side adjacent to the first side of the first light guide plate;
a fourth light guide plate having a fourth side adjacent to the second side of the second light guide plate, wherein the third light guide plate and the fourth light guide plate are disposed along the first direction while the first light guide plate and the third light guide plate are disposed along a second direction and, the second light guide plate and the fourth light guide plate are disposed along the second direction; and
a plurality of luminous elements, disposed along the third side and the fourth side, for emitting lights toward the third side and the fourth side, respectively, wherein the light source module further includes a portion of the luminous elements disposed along the first side and adjacent to the third side, along the second side and adjacent to the fourth side, along the third side and adjacent to the first side, and along the fourth side and adjacent to the second side.

10. A backlight module, comprising:
a substrate having a surface;
a first light guide plate disposed on the substrate, the first light guide plate having a first side;
a second light guide plate disposed on the substrate, the second light guide plate having a second side face to the first side; and
a light source module including a plurality of first luminous elements and a plurality of second luminous elements disposed on the surface of the substrate, wherein the first luminous elements are disposed along the first side and emit lights thereto while the second luminous elements are disposed along the second side and emit lights thereto, the first luminous elements and the second luminous elements act simultaneously.

11. The backlight module of claim 10, wherein the first luminous elements are connected in series to form a first luminous element set while the second luminous elements are connected in series to form a second luminous element set, and the first luminous element set and the second luminous element set are in turn connected in series to form the light source module.

12. The backlight module of claim 10, wherein the first luminous elements and the second luminous elements are interlaced and connected in series to form the light source module.

13. The backlight module of claim 10, wherein the first luminous elements and the second luminous elements are interlaced to form a single line structure.

14. The backlight module of claim 13, wherein the first luminous elements are connected in series to form a first luminous element set while the second luminous elements are connected in series to form a second luminous element set, and the first luminous element set and the second luminous element set are in turn connected in series to form the light source module.

15. The backlight module of claim 13, wherein the first luminous elements and the second luminous elements are interlaced and connected in series to form the light source module.

16. The backlight module of claim 10, wherein the length of the first light guide plate or the length of the second light guide plate is an integral multiple of the length of the light source module.

17. The backlight module of claim 10, wherein the length of the first light guide plate or the length of the second light guide plate is equal to the length of the light source module.

18. The backlight module of claim 10, wherein the first light guide plate and the second light guide plate completely overlap the substrate.

19. The backlight module of claim 10, wherein the first light guide plate and the second light guide plate partially overlap the substrate.

20. A backlight module, comprising:
a substrate having a surface;
a first light guide plate disposed on the substrate, the first light guide plate having a first side;
a second light guide plate disposed on the substrate, the second light guide plate having a second side face to the first side;
a third light guide plate disposed on the substrate, the third light guide plate having a third side;
a fourth light guide plate disposed on the substrate, the fourth light guide plate having a fourth side face to the third side; and
a light source module including a plurality of first luminous elements and a plurality of second luminous elements disposed on the surface of the substrate, wherein the first luminous elements are disposed along the first side and the third side and emit lights thereto while the second luminous elements are disposed along the second side and the fourth side and emit lights thereto, the first luminous elements and the second luminous elements act simultaneously.

21. The backlight module of claim 20, wherein the first luminous elements and the second luminous elements are light-emitting diodes.
